(19) United States
(12) Patent Application Publication
(10) Pub. No.: US 2016/0372860 A1
(43) Pub. Date: Dec. 22, 2016

(54) SOLDER-LESS, CRIMP-LESS, OVER-MOLDED SIGNAL CABLE

(71) Applicant: D'Addario & Company, Inc., Farmingdale, NY (US)

(72) Inventors: James D'Addario, Old Westbury, NY (US); Robert J. Cunningham, Levittown, NY (US)

(21) Appl. No.: 15/185,220

(22) Filed: Jun. 17, 2016

Related U.S. Application Data
(60) Provisional application No. 62/182,784, filed on Jun. 22, 2015.

(51) Int. Cl. H01R 13/58; H01R 24/38

(52) U.S. Cl. CPC H01R 13/5845; H01R 24/38; H01R 2103/00

(57) ABSTRACT

A signal cable comprising a plurality of plug parts forming a plug that is operatively connected to signal and ground conductors at one end of a coaxial cable, wherein the plug parts and the end of the coaxial cable are held together only by an insulating overmold material. The assembly has four operatively connected plug parts (12, 20, 24, 30); a signal conductor at one end (42) of a coaxial cable (40) conductively connected to one of the plug parts (12); and an overmold (54) encapsulating the end of the cable and a conductive connection between a cable ground sleeve and another plug part (30).

### BACKGROUND

The present invention relates to solderless, high quality audio signal cables.

Audio signal cables have been used for many years for musical instrument amplification, sound reinforcement and high fidelity signal transmission. These cables are typically coaxial, with a central signal conductor surrounded by insulation, a ground conductor, and a covering. Because the cable length requirements of the end users can vary widely, cables are often sold without attached end connectors. The purchaser trims the ends of the cables to the desired a connector is attached at each end.

Attaching the connectors is typically tedious, requiring crimping or soldering, and subject to poor connectivity of the cable conductors to the respective contacts on the connectors.

### SUMMARY

The present invention is directed to components and associated method of assembly, for producing a very high quality audio signal cable, suitable for musical instrument amplification, sound reinforcement and high fidelity signal transmission, without the need for crimping or soldering connections and pre-assembling the plug components.

From a general perspective, the invention is directed to a signal cable comprising a plurality of plug parts forming a plug that is operatively connected to signal and ground conductors at one end of a coaxial cable, wherein the plug parts and the end of the coaxial cable are held together only by an insulating overmold material.

In the disclosed embodiment, only four plug parts are necessary.

One plug part includes a cylindrical body having an axial bore in which the one end of the coaxial cable is situated, and at least one radial through hole. Overmold material surrounds the one part, fills the at least one hole, and intimately surrounds the one end of the cable. Also, a ground connector is pressed against a ground sheath in the coaxial cable and the pressing of the ground connector to the ground sheath is performed only by insulating overmold material.

The unique geometry of the components requires no more than four easily manufactured parts to be inserted into an automated or semi-automated mold with fixtures which in one step creates solid, permanent connections for the signal and ground terminations and then creates an injection molded plug body that securely holds all four plug components and the cable into place.

The advantages are the elimination of very costly soldering and/or crimpling labor steps in the process, enabling manufacture of the product in an automated manufacturing cell, thus significantly reducing cost while maintaining high-quality, extremely-durable connections. Because these cables are often used in harsh live, on-stage and/or studio conditions the cable assembly must be capable of sustaining its quality connections and tone without failure.

Conventional cables incorporate plug assemblies with additional parts to accommodate crimping or soldering and require pre-assembly which also adds additional cost to the final assembly. This process takes four relatively inexpensive plug components and a coaxial signal cable and in one step creates a professional quality audio signal cable.

### BRIEF DESCRIPTION OF THE DRAWING

An embodiment of the invention will described below with reference to the accompanying drawing, in which:

FIG. 1 shows a complete overmolded assembly consisting of four plug parts, a cable and an overmolded plug body;

FIG. 2 shows the signal tip and pin as one part;

FIGS. 3a and b show a plastic signal tip insulator sleeve with front ring slid onto the signal tip and pin;

FIGS. 4a and b show ground element with tube and body 28 slid onto the sub-assembly shown in FIG. 3;

FIGS. 5a and b show details of the stamped metal ground connection and where it is attached to the plug body;

FIGS. 6a and b show how the stamped metal ground connection is slipped onto the ground sleeve/body;

FIGS. 7a and b show the cable before and after insertion into the ground tube/body and on to the signal pin connection;

FIG. 8 is an exploded view of the assembly showing the upper and lower half of the mold that creates the over-molded plug body while locking all components together;

FIG. 9 is a side view of the assembly and the collet fixture, which holds the plug parts together during over-molding;

FIG. 10 is a cross section view of FIG. 9, with overmold;

FIG. 11 shows the inside features of the lower half of the mold; and

FIG. 12 shows details of the over molded region in FIG. 10.

### DETAILED DESCRIPTION

FIG. 1 shows the completed overmolded assembly 10 consisting of four plug parts, the cable and an overmolded plug body. The plug tip and signal pin are one part. Conventionally, these are two parts that are pressed together. The ground tube and body together form a second part, the tip insulator is a third part and the ground connector strain relief ring is the fourth part. This ring is a stamped part that has tangs to engage the braided shield for the ground connection. In addition, the polymer overmold plug body and stripped coax cable are also shown. The modified 5C collet is part of the mold fixture and holds the plug parts tightly together and against the overmold to make a seal and prevent polymer from flashing around the ground tube and body part during assembly.

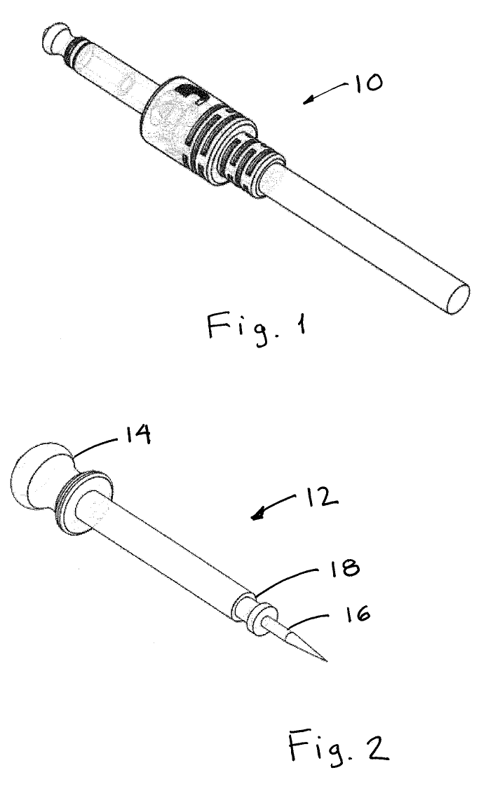

FIG. 2 shows how the signal tip 14 and pin 16 form one part 12. The pointed pin is forced into the center of the stranded coaxial signal cable, making a reliable connection that will be covered with injection molded plastic during the molding step. One or more grooves 18 are filled with polymer during the over-molding process. This holds the plug parts, cable and over-molded parts together after over-molding.

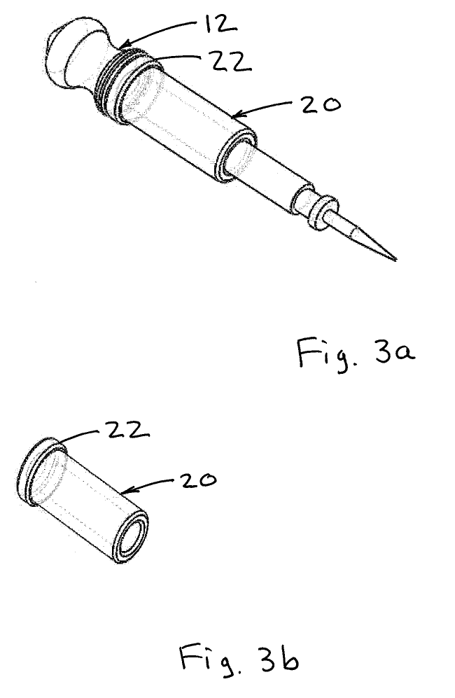

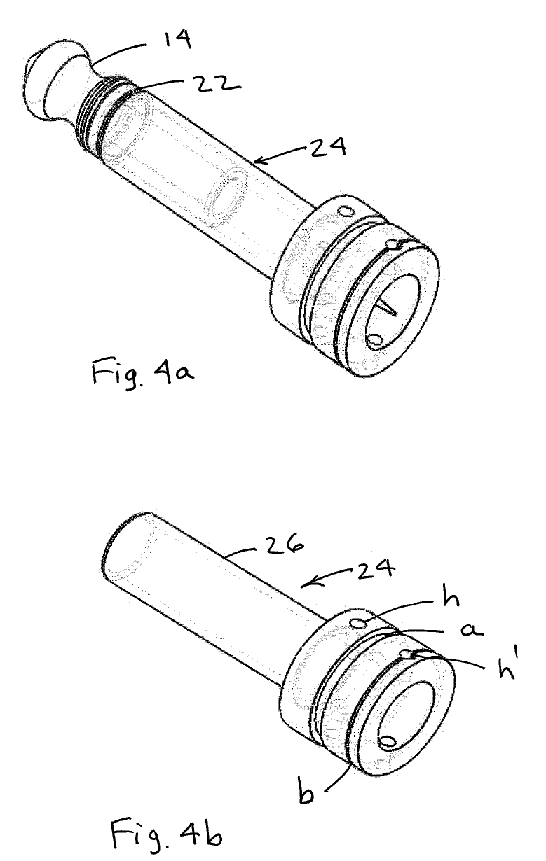

FIGS. 3a and b show how the plastic signal tip insulator sleeve 20 with front ring 22 is slid onto the signal tip and pin 12. This separates the signal component from the ground tube/body.

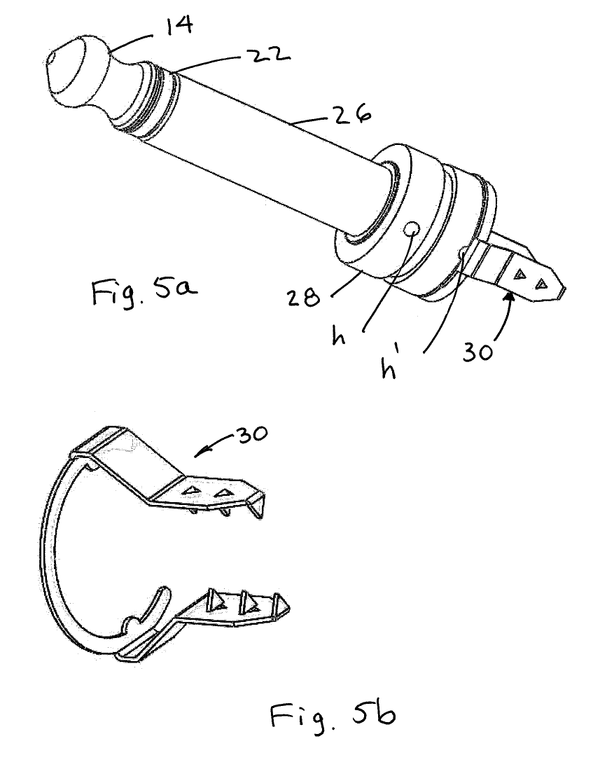

As shown in FIGS. 4a and b, ground element 24 with tube 26 and body 28 is slid onto the sub-assembly shown in FIG. 3. During over-molding, plastic flows into the one or more grooves or recesses a, b and through the port holes such as h, filling the body of the plug and holding the assembly together (i.e., at least pin 16 and free end of cable within bore 56). Two of the holes such as h′ in the back groove b also locate the stamped ground connector and strain relief part.

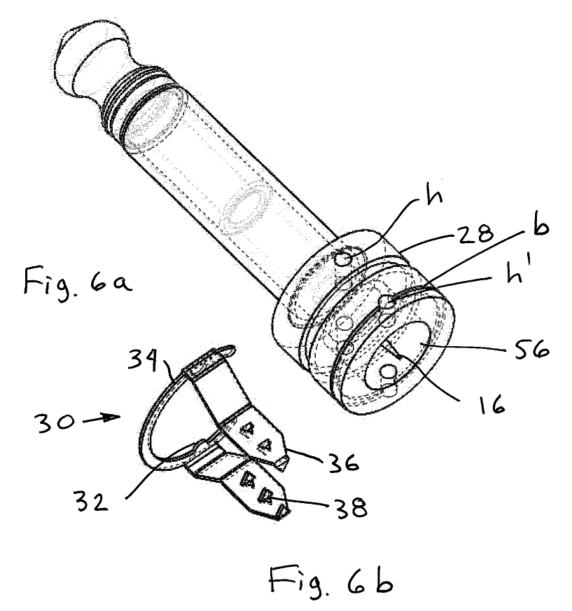

FIGS. 5a and b show details of the stamped metal ground connection 30 and where it attaches to the plug body. According to FIGS. 6a and b the stamped metal ground connection is slipped onto the ground sleeve/body into the back groove b. Two small protrusion features 32 on an arcuate portion 34 of the stamping engage with holes h′ in the plug body to assure easy alignment and connectivity to the ground tube. This part has a pair of arms 36 with barbs or teeth 38 that during over-molding pierce the coaxial cable outer jacket, engaging the braided shield to make the ground connection. They also serve as secure strain relief. Features in the mold close on these two arms forcing them securely into the cable and ensuring positive strain relief.

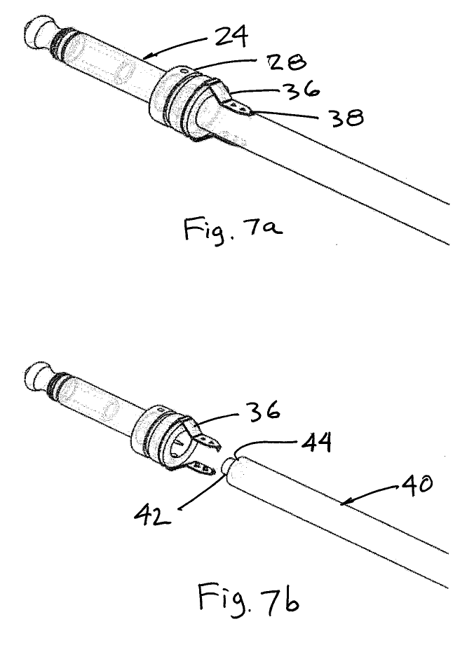

FIGS. 7a and b show the cable 40 before and after insertion into the ground tube/body 24 and on to the signal pin connection. The cable is partially stripped down to expose a portion of the still insulated signal wire 42. Only the outer cable jacket and the braided shield material 44 are stripped away. This is to step the cable back in the assembly to avoid the possibility that a strand of coax shield (ground) could accidentally contact the signal pin during assembly. The coax cable is automatically cut to length, stripped and tied by an outed machine process in the work cell. It is presented to the operator who will be assembling the plug parts into the mold, inserting the stripped cable and cycling the overmold process.

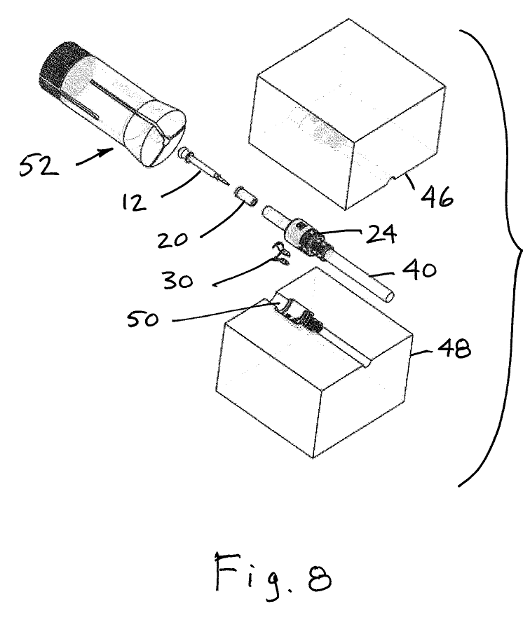

FIG. 8 is an exploded view of the assembly showing the upper 46 and lower 48 half of the mold that creates the over-molded plug body while locking all components together. The features 50 in the lower half of the mold force the connection tangs on the ground connector stamped part into the outer cable jacket and braided shield, thus making the ground connection. It also creates strain relief cuts in the overmolded part allowing the plug body to flex when in use. A collet fixture 52 is used to hold the plug parts securely together prior and during the over-molding process.

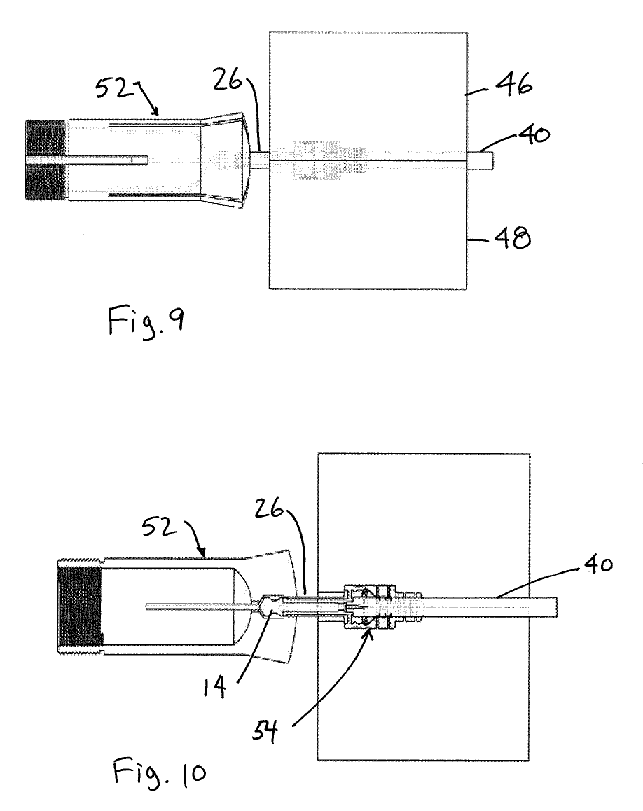

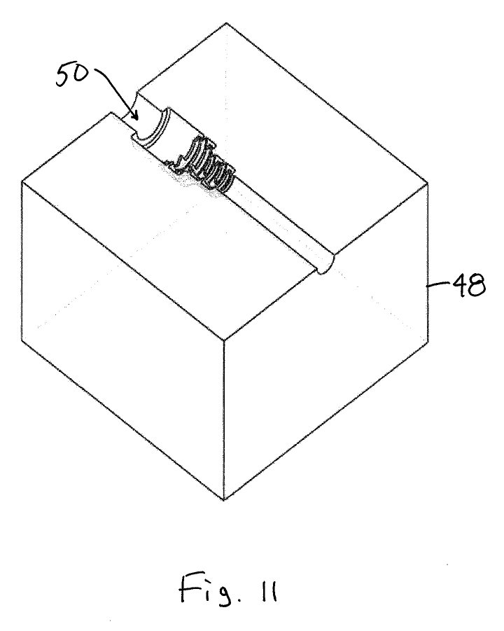

FIG. 9 is a side view of the assembly and the collet fixture. The collet simply holds the plug parts together during over-molding. The upper and lower mold parts close on the plug parts and polymer is injection molded into the ground tube/body and around all the other internal components, forming the outer plastic plug body at the same time. FIG. 10 is a cross section view of FIG. 9, with overmold 54.

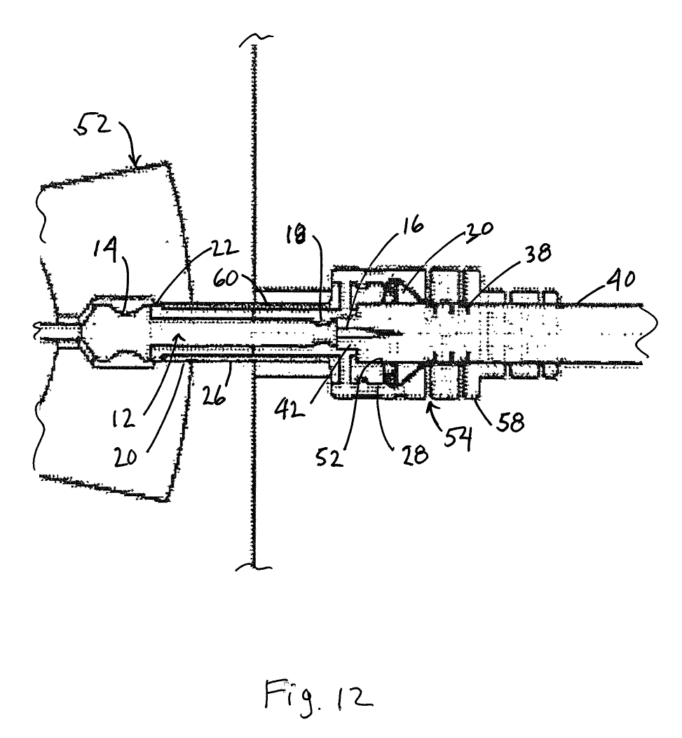

FIG. 11 shows the inside features of the lower half of the mold. The three larger circular protrusions force the tangs of the stamped ground connector into the braided shield to make the ground connection and create strain relief.

FIG. 12 shows details of the over molded region in FIG. 10. The conductive signal back pin 16 with profile 18 is embedded in overmold material. The insulating sleeve 20 surrounds a forward portion of the signal conductor 12. The ground element 24 has a ground tube 26 around a portion of the insulating sleeve and a ground body 28 having a bore 56 for receiving the coaxial cable 40. The ground connector 30 is supported on the ground body 28 and extends rearward with the tangs 38 that have been forced through the cable jacket into the ground sheath. The coaxial cable front end with central signal conductor engages the signal pin 16. The insulating overmold encapsulates the ground connector 30 and the ground body 28, the forward end 42 of the cable, and the profile 18. The overmold also forms a strain relief collar 58 that extends rearward of the ground connector 30. The overmold can also cover a back portion 60 of the ground tube.

It can thus be appreciated that the foregoing discloses a signal cable 10 comprising: four operatively connected plug parts 12, 20, 24, 30; a signal conductor at one end 42 of a coaxial cable 40 conductively connected to one of the plug parts 12; and an overmold 54 encapsulating the end of the cable and a conductive connection between a cable ground sleeve and another plug part 30.

The plug parts include (i) a conductive signal pin 12; (ii) an insulating sleeve 20 around a portion of the signal pin; (iii) a ground element 24 having a ground tube 26 around a portion of the insulating sleeve and a ground body 28 having a bore 56 for receiving the coaxial cable; and (iv) a ground connector 30 supported on the ground body and extending rearward with tangs 38. The coaxial cable 40 has a front end with central signal conductor 42 engaging the signal pin and the tangs engaging the cable ground conductor. The insulating overmold 54 encapsulates the ground connector 30 and the ground body 28.

A method of assembling a signal cable 10 is also disclosed. The steps include inserting a free end of the coaxial cable 40 into the bore of the ground body until the central signal conductor contacts the back pin 16, and placing the ground body 28 with inserted cable, in a mold. The mold is closed and a pressurized flow of insulating material is delivered through the mold through the ground body whereby a first portion of the insulating material flows into the bore around the cable and surrounds a portion of the signal pin 12 within the ground tube 26, and a second portion of the insulating material surrounds the ground body 28. The mold is opened and the signal cable 10 is removed, resulting in an over molded plug with the signal pin conductively engaging the central signal conductor and the ground conductor conductively engaging the ground sheathing.

1. A signal cable (10) comprising: four operatively connected plug parts (12, 20, 24, 30); a signal conductor at one end (42) of a coaxial cable (40) conductively connected to one of the plug parts (12); and an overmold (54) encapsulating the end of the cable and a conductive connection between a cable ground sleeve and another plug part (30).

2. The signal cable of claim 1, wherein
a. the plug parts include (i) a conductive signal pin (12); (ii) an insulating sleeve (20) around a portion of the signal pin; (iii) a ground element (24) having a ground tube (26) around a portion of the insulating sleeve and a ground body (28) having a bore (56) for receiving the coaxial cable; and (iv) a ground connector (30) supported on the ground body and extending rearward with tangs (38);
b. a coaxial cable (40) having a front end with central signal conductor (42) engages the signal pin and the tangs engage the cable ground conductor; and
c. the insulating overmold (54) encapsulates the ground connector (30) and the ground body (28).

3. The signal cable of claim 1, wherein
a. the plug parts include (i) a conductive signal pin (12) with front tip (14) and a back pin (16); (ii) an insulating sleeve (20) around the signal pin between the tip and the back pin; (iii) a ground element (24) having a ground tube (26) around a portion of the insulating sleeve and a ground body (28) having a bore (56) for receiving the coaxial cable; and (iv) a ground connector (30) supported on the ground body;
b. a coaxial cable (40) having a front end with central signal conductor (42) engages the back pin (16) and the ground connector engages the cable ground conductor; and
c. the insulating overmold (54) encapsulates the ground connector (30) and extends within the ground body (28), within the ground tube (26) and around the back pin (16).

4. A signal cable comprising: (i) a conductive signal pin (12) extending along a longitudinal axis from a front signal tip (14) to a back pin (16); (ii) an insulating sleeve (20) around the signal pin, abutting the signal tip and terminating forward of the back pin; (iii) a conductive ground element (24) including a ground tube (26) and a ground body (28), wherein the ground tube passes over the insulting sleeve, with a front spaced from the signal tip to a back that extends rearward of the back pin, and the ground body is an externally profiled (a, b) hollow cylinder that extends rearward from the ground tube such that a cable bore (56) is formed through the ground element to the back pin; (iv) a ground connector (30) supported on the ground body and having connector arms (36) that extend rearward with tangs (38) facing the longitudinal axis; (e) a coaxial cable (40) in said cable bore, having a front end (42) with central signal conductor engaging the back pin (16) and a cable portion (44) rearward of the ground body where the tangs of the connector engage the cable ground conductor; and (f) an insulating overmold (54) encapsulating the ground connector and ground body.

5. The signal cable of claim 4, wherein the ground connector (30) has internal mounting features (32) that engage external mounting features (h′) on the ground body.

6. The signal cable of claim 4, wherein the ground body (28) has a profiled exterior (a, b) and the overmold intimately engages the profiles.

7. The signal cable of claim 4, wherein the ground body has a plurality of external arcuate recesses (a,b) and through holes (h, h′) to the cable bore; the ground connector has an arcuate portion (34) that is situated in one of said recesses with features (32) that engage the holes (h′); and the overmold intimately engages the recesses and holes.

8. The signal cable of claim 4, wherein the signal pin (12) has a profiled exterior (18) immediately forward of the back pin (16); and the overmold extends forward of the ground body (28) within the ground tube (26) to intimately engage the signal pin profile.

9. The signal cable of claim 4, wherein
a. the ground connector (30) has internal mounting features (32) that engage external mounting features (h′) on the ground body;
b. the ground body has a profiled exterior (a, b) and the overmold intimately engages the profiles; and
c. the overmold extends forward of the ground body within the ground tube (26).

10. The signal cable of claim 9, wherein
a. the ground body (28) has a plurality of external circular recesses (a, b) and having through holes (h, h′) to the cable bore (56);
b. the ground connector (30) has an arcuate portion (34) that is situated in one of said recesses with features that engage the holes (h);
c. the overmold intimately engages the recesses and passes through at least some of the holes into the bore (56), with intimate contact against the cable.

11. The signal cable of claim 9, wherein the overmold integrally extends rearward from the ground body as a tubular strain relief member around the cable and ground connector.

12. A method of assembling a signal cable (10) comprising:
a. selecting a coaxial cable (40) having a central signal conductor, an insulator around the signal conductor, a conductive ground sheath around the insulator, and a covering;
b. forming a plug including (i) a conductive signal pin (12) having a forward tip (14) and a back pin (16) which define a plug axis; (ii) an insulating sleeve (20) concentrically around a portion of the signal pin; (iii) a ground element (24) having a ground tube (26) concentrically around a portion of the insulating sleeve and a ground body (28) having an axial bore (56) for receiving the coaxial cable and at least one radial port (h); and (iv) a ground connector (30) supported on the ground body and extending rearward with tangs (38);
c. inserting a free end of the coaxial cable (40) into the bore of the ground body until the central signal conductor contacts the back pin (16) and the tangs overlay a portion of the covering of the cable;
d. placing the ground body (28) with inserted cable, the ground connector (30), and overlaid portion of the cable in a mold;
e. closing the mold and delivering a pressurized flow of insulating material through the mold to the ground body (28) and covering portion of the cable including ground connector, whereby
a first portion of said insulating material flows through said at least one port to fill the bore around said cable and to surround a portion of the signal pin (12) within the ground tube (26); and
a second portion of said insulating material surrounds the ground body (28) and ground connector (30) and pushes the tangs (38) through the covering (44) into conductive penetration of the ground sheath; and
f. opening the mold and removing the finished signal cable (10), having an over molded plug with the signal pin conductively engaging the central signal conductor and the ground conductor conductively engaging the ground sheathing.

13. The method of claim 12, wherein upon completion of step f, the finished signal cable is defined by claim 3.

14. The method of claim 12, wherein upon completion of step f, the finished signal cable is defined by claim 10.

15. The method of claim 12, wherein upon completion of step f, the finished signal cable is defined by claim 11.

16. A method of assembling a signal cable (10) with plug parts including (i) a conductive signal pin (12) with front tip (14) and a back pin (16); (ii) an insulating sleeve (20) around the signal pin between the tip and the back pin; (iii) a ground element (24) having a ground tube (26) around a portion of the insulating sleeve and a ground body (28) having a bore for receiving the coaxial cable; and (iv) a ground connector (30) supported on the ground body, wherein the method comprises:
a. inserting a free end of the coaxial cable (40) into the bore of the ground body until the central signal conductor contacts the back pin (16);
b. placing the ground body (28) with inserted cable, in a mold;
c. closing the mold and delivering a pressurized flow of insulating material through the mold through the ground body whereby
a first portion of said insulating material flows into the bore around said cable and surrounds a portion of the signal pin (12) within the ground tube (26); and
a second portion of said insulating material surrounds the ground body (28); and
d. opening the mold and removing the signal cable (10), having an over molded plug with the signal pin conductively engaging the central signal conductor and the ground conductor conductively engaging the ground sheathing.
